(19) United States
(12) Patent Application Publication
(10) Pub. No.: US 2011/0062085 A1
(43) Pub. Date: Mar. 17, 2011

(54) Method of Removing Metal Contaminants from High-Density Brines

(75) Inventors: Jay P. Deville, Spring, TX (US); Matthew L. Miller, Spring, TX (US); Stephen W. Almond, Spring, TX (US); Douglas J. Harrison, Tomball, TX (US)

(73) Assignee: Halliburton Energy Services, Inc., Duncan, OK (US)

(21) Appl. No.: 12/559,713

(22) Filed: Sep. 15, 2009

(51) Int. Cl. C02F 1/52

(52) U.S. Cl. 210/719; 210/778; 210/224; 210/209

(57) ABSTRACT

A method for the removal of soluble metal ion contamination from fluids is disclosed. The method includes passing the contaminated fluid through a filter medium comprising a reducing metal and a filter aid, such as diatomaceous earth, and collecting a filtrate with lower concentration of soluble metal ion contamination. The reducing metal can have a reduction potential of from −0.50 volt to −3.10 volt and can be capable of reducing the soluble metal ions to insoluble metal, which can then be entrapped in the filter medium or otherwise separated.

### FIELD

The present invention generally relates to the removal of metal contaminants, particularly iron, from high-density brines, such as those used in hydrocarbon completion and workover operations.

### BACKGROUND

High-density brines are salt-saturated fluids that are useful in completion, workover, and other operations performed on hydrocarbon wells. They generally have a density from about 8 to 20 ppg (pounds per gallon), which properties are determined by the brine composition. High-density brines are generally comprised of salts of sodium, calcium, or zinc, or some combination thereof. They are desirable for use with hydrocarbon production because they are generally clear and solid-free fluids. However, high-density brines can be undesirably expensive. Generally, it is only economical to use these types of fluids when it is possible to reclaim them for continued use.

Regeneration of high-density brines involves the removal of contaminants that pose a risk of damaging the formation or reducing production. Removal is usually by filtration, which can remove solid contaminants but generally not colloidal and/or soluble species. One category of concern is the soluble heavy metal contaminants, and of particular concern is iron. Because high-density brines are corrosive, they can collect iron from the tubings and casings in the well during their use. Additionally, iron can also be accumulated from starting materials and during transport, storage, and handling of the brine, making a degree of regeneration necessary even before the brine's first use. Due to an inherently low pH, zinc brines are particularly corrosive and therefore are particularly prone to the solubilization and stabilization of iron ions, making zinc brines one of the most difficult of the high-density brines to treat for iron contamination.

Iron contamination in high-density brines can comprise ferrous (Fe²⁺) and ferric (Fe³⁺) iron ions, as well as iron insolubles such as iron hydroxide and solid iron. The soluble ions generally cannot be removed by normal filtration, as they are part of the solution. Prior art methods of removing soluble iron have centered on means of precipitating the ions out of the high-density brine solution. For example, some methods involve raising the pH of the brine with basic chemicals to initiate the formation of insoluble iron hydroxide from the iron ions. Raising the pH in zinc brines can be difficult because the brine is buffered by zinc hydroxide complexes. Additionally, the pH of the brine must be restored prior to its continued use. Another prior art method involves the use of oxidizing agents. In zinc brine especially, a large portion of the iron ions exist in the ferrous oxidation state, due to the low solubility of oxygen in the brine. The ferrous, iron (II) oxidation state is more soluble than the ferric, iron (III) oxidation state, and thus, oxidizing agents can convert iron ions to their less soluble state. Another prior art approach has been the use of chelating agents to sequester the ions for easy removal.

The prior art methods have generally involved elaborate and costly procedures, requiring an undesirable expenditure of time and money. In many cases, the procedure alters the chemical and physical properties of the high-density brines, such that steps must be taken to restore composition, viscosity, density, pH, and other features of the brines before they can be used. Adjusting the pH, for example, can compromise the integrity of the brine density. Another problem is that the prior art methods involve procedures and chemicals, such as oxidizers, that are generally unsuitable for use at a rig site. Thus, such methods have generally been performed off-site, in a laboratory, thus requiring the time and cost of transporting the brines along with the cost of the regeneration procedure.

There is a need for methods to reclaim high-density brines, in order to improve the economics of their use. Such methods ideally would be relatively simple and economical and could be performed on-site.

### SUMMARY

The present invention, in its many embodiments, is a method for the removal of soluble metal ion contamination from fluids that includes passing the contaminated fluid through a filter medium comprising a reducing metal and a filter aid, such as diatomaceous earth, and collecting a filtrate with lower concentration of metal ion contamination. The reducing metal can have a reduction potential of from about −0.50 volt to about −3.10 volt and can reduce the soluble metal ions to insoluble solid metal, which can then be entrapped in the filter medium or otherwise separated.

One embodiment is a method for the removal of iron contamination from high-density brine, especially zinc brine, by using a combination of metallic zinc and a filtration system. The metallic zinc acts by reducing soluble iron ions to insoluble iron, which can then be removed by the filter.

In one embodiment, the filter media comprises metallic zinc and diatomaceous earth as a filter aid. According to this embodiment, the method comprises contacting contaminated brine with the filter media and collecting a reclaimed filtrate with a lower concentration of iron contamination.

In another embodiment, diatomaceous earth can be added as body feed to the contaminated brine to augment the filtration and prevent clogging. In another embodiment, metallic zinc can be pre-mixed with the contaminated brine prior to filtration. In another embodiment, the contaminated brine can pre-filtered with a conventional filter, to remove solids, before contacting the contaminated brine with metallic zinc.

In one embodiment, the contaminated brine is zinc brine. In alternate embodiments, the contaminated brine is another high-density brine or another aqueous fluid. In one embodiment, contaminants other than iron, especially heavy metal contaminants, are removed by the method of the invention.

In another embodiment, the method of the invention does not require any procedures for correcting the physical and chemical properties of the reclaimed brine before it is suitable for reuse.

In another embodiment, the method of the invention can be performed on location at a well or rig site, using a plate and frame type filter assembly.

An alternate embodiment is a method for the removal of iron contamination from high-density brines. A high-density brine having iron contamination is passed through a filter media comprising metallic zinc and a filter aid. Ferrous and/or ferric iron ions are reduced to metallic iron through reaction with the metallic zinc. Metallic iron is filtered out of the brine in the filter media and the filtrate is collected. The filtrate contains a lower concentration of iron contaminants than the original contaminated brine. The high-density brine can be a zinc brine. The filter aid can include diatomaceous earth. The filter aid can additionally be added to the contaminated brine upstream of the filter. The metallic zinc can be in the form of powdered zinc or zinc dust. The filter media can be used in a plate and frame type filter assembly. The method can be performed on location at a well/rig site.

### DETAILED DESCRIPTION

The present invention includes a method for the removal of metal contaminants from high-density zinc brines, especially for the removal of iron ions that are dissolved in the brine. In general, the method involves the use of a metal, such as metallic zinc, to reduce iron ions to solid metallic iron, which can be removed with a filter or by some other manner.

In one embodiment, the method comprises passing contaminated zinc brine through a filter media comprising metallic zinc and a filter aid such as diatomaceous earth. The metallic zinc can react with ferric iron(III) ions to reduce them to ferrous iron(II) ions and can further reduce iron(II) ions to solid iron metal. Equations 1 and 2, shown below, demonstrate the reaction that can take place between zinc filter media and iron ions present in the contaminated brine.

Zn₍ₛ₎+2Fe⁺³_{(aq)}----->Zn⁺²_{(aq)}+2Fe⁺²_{(aq)} Equation 1.

Zn₍ₛ₎+Fe⁺²_{(aq)}----->Zn⁻²_{(aq)+Fe}₍ₛ₎ Equation 2.

Thus, the metallic zinc can reduce ferrous and ferric iron ions to metallic iron. Unlike the iron ions, solid metallic iron is insoluble in the brine and precipitates out of the solution, to be collected on the filter. Other solid forms and insoluble forms of iron, such as iron hydroxide, can also collect on the filter. Thus, the contaminated brine passes through the filter; ionic forms of iron transform to insoluble iron; the insoluble forms of iron become entrapped in the filter aid as the brine solution passes through; and the filtrate contains a lower concentration of iron contamination than the brine prior to treatment.

Due to the reduction potentials of iron and zinc, Equations 1 and 2 generally proceed only in the direction indicated. As there is no thermodynamic driving force for metallic iron to reduce zinc ion, Equations 1 and 2 generally are not reversible. As indicated by Equations 1 and 2, zinc ions form and enter the brine solution as the iron is reduced and precipitated out. The presence of zinc ions generally does not negatively affect the chemical and/or physical properties of the brine, especially if the brine is composed of zinc. In the case of zinc brines, zinc ions can potentially help to maintain the fidelity of the brine density. The reduction potential of iron {Fe⁺²+2e⁻----->Fe} is −0.409 volts, the reduction potential of zinc {Zn⁺²+2e⁻----->Zn} is −0.763 volts. Metals such as zinc have sufficient reduction potential to reduce iron ions to solid metallic iron.

The contaminated brine can be brine that has been used in a completion, workover, or other operation at a well site. Optionally, the contaminated brine can be brine that has not been used in well site operations. In this case, the brine can be contaminated from its exposure to iron during its manufacture, storage, transport, and/or handling. The method can be performed on location at a well site or a rig site. Optionally the method can be performed at a site that prepares and/or stores fluids that can be used industrially, such as a location that prepares and/or stores fluids that can be used in the drilling, completion, treatment or workover of a hydrocarbon well.

In one embodiment the filter media generally comprises metallic zinc and a filter aid such as diatomaceous earth. The metallic zinc can be in a powdered form; optionally it can be used in other forms, such as zinc dust or granular zinc. Zinc can be obtained commercially in various sizes such as nanopowder (<50 nanometers), dust (<10 microns), coarse powder (<150 microns), and larger particle sizes. The amount of metallic zinc used can be in molar excess of the iron contamination. The level of iron contamination can be detected using known methods. The filter aid can be a type other than diatomaceous earth, such as glass fiber, glass wool, silica gel, alumina, paper, activated charcoal, and other materials. For instance, the filter aid can comprise diatomaceous earth and calcium silicate. The composition of the filter media can comprise any suitable ratio of metallic zinc to filter aid to perform the reduction of iron ions to solid metallic iron. Non-limiting examples of possible metallic zinc to filter aid ratios can range from 1:1,000 to 1:1 by mass, alternately from 1:100 to 1:5.

In another embodiment, the filter media comprises metallic zinc and a filter aid, and the filter aid is also introduced as body feed into the contaminated brine upstream of the filter. Body feeds, such as diatomaceous earth, can be slurried with the contaminated brine to provide an increasing depth of filter cake and prevent filter plugging at the filter surface. In another embodiment, the contaminated brine can be pre-filtered through filter media such as diatomaceous earth to remove solids and other insolubles, prior to treating the brine with a reducing metal containing filter media. Such a procedure can be useful, for instance, to remove iron hydroxide, which is a gelatinous, sticky substance prone to clogging some types of filters. In this embodiment, additional diatomaceous earth present as body feed can be useful to prevent filter plugging.

The filter assembly can be any type known in the art and can be either batch or continuous. Some known types of filters to which the present invention is applicable include parallel plate filters, Nutsche filters, rotary, and vertical or horizontal tubular filters. One feature of the present invention is that it is compatible with plate and frame type filters that can be operated at a rig site, thus eliminating the need to transport the contaminated brine for treatment in a lab.

The temperature can be any suitable to perform the reduction of iron ions to solid metallic iron, such as ambient temperature. Higher temperatures can potentially increase the level of precipitation of iron from solution. The temperature can optionally be from about 10° C. to about 90° C. The pressure can be ambient or higher and is not limiting in the present invention. The flow rate can be any suitable for the reaction and is not limiting. The length of filtration time can also vary and is non-limiting. In illustrative examples the filtration can last from minutes to days, for instance, from about 12 hours to about four days, or optionally from about two to twenty hours.

The method of the present invention can remove other insolubles from brine besides insoluble iron. For instance, brine that was used in a completion or work-over operations can contain contaminants such as water, drilling mud, formation materials, rust, scale, pipe dope, and viscosifiers and bridging agents used for fluid-loss-control pills. Of the aforementioned contaminants, those capable of being removed by normal filtration can also be removed by the method of the present invention. Because metallic zinc can react with and reduce heavy metal ions besides iron ions, the present invention can also be used to remove other soluble metals ions, including chromium, manganese, cobalt, nickel, lead, tin, copper, and the like, that may be present in the contaminated brine.

In alternate embodiments of the invention, elements other than zinc, or in addition to zinc, can be used to remove soluble metals ions, such as iron, from brine. Other metals capable of the reduction and removal of iron and other ions can include aluminum, calcium, chromium, lithium, magnesium, potassium, sodium, strontium, and titanium. A non-limiting listing of metals that have a reduction potential that may be used in the present invention is shown in Table 1. Metals having a reduction potential of from −0.50 volt to −3.10 volt can be utilized in the present invention. Compounds and other forms of these elements can likewise be utilized in the present invention. Data in Table 1 taken from The Handbook of Chemistry and Physics, 56'th Ed, CRC Press, pages D-141 to D-146.

TABLE 1

| Reducing Metal | Reduction Potential (volt) |
|---|---|
| Li | −3.05 |
| Ca | −3.02 |
| Rb | −2.93 |
| K | −2.92 |
| Cs | −2.92 |
| Ba | −2.90 |
| Sr | −2.89 |
| Na | −2.71 |
| Mg | −2.38 |
| La | −2.37 |
| Y | −2.37 |
| Sc | −2.08 |
| Al | −1.71 |
| Be | −1.70 |
| Ti | −1.63 |
| V | −1.20 |
| Mn | −1.03 |
| Te | −0.92 |
| Se | −0.78 |
| Zn | −0.76 |
| Cr | −0.74 |
| Ga | −0.56 |

While the invention has been described with reference to its use with zinc brines, similar chemistry and technique can be applied to other high-density brines. High density brines comprise various combinations of the following salts: calcium chloride, calcium bromide, sodium chloride, sodium bromide, and zinc bromide, among others. The present invention is also applicable for the treatment of fluids other than high-density brines. For instance, the method of the invention can be used to remove iron from well water, boiler feedwater, and drinking water.

A feature of the present invention is that it generally does not require procedures to correct the pH, density, or other physical and chemical properties of the reclaimed brine before it is suitable for reuse. However, known procedures that can aid the removal of iron may be used, and such procedures can require adjustment of the reclaimed brine's chemical and physical properties before its reuse. Such known procedures include the addition of oxidizing agents, reducing agents, and chemicals to alter the pH. Oxidizing agents can be any known in the art, such as peroxides or hypochlorites, and can oxidize iron and other metal ions to a less soluble valence state, as well as remove harmful organic contaminants. Since the mechanism of the metallic zinc in the present invention works via reduction, any oxidation procedure can be performed separately from the steps of the method in which zinc is employed. Reducing agents, such as sulfites, can be used in conjunction with zinc, to reduce iron ions to metallic iron. Chemicals used to raise the pH include carbonates and hydroxides, and can transform iron ions into insoluble iron hydroxide. Chemicals used to lower the pH include mineral acids. If any of the aforementioned optional procedures are employed in conjunction with the present invention, any procedures known in the art can be employed for restoring the brine to physical and chemical properties suitable for reuse. For instance, additional salt, such as zinc bromide, can be added to the reclaimed brine to increase its density.

### Example

The following example gives a better understanding of the present invention, but represents only a single embodiment and is not meant to be limiting in any way.

A cell was packed with 18.5 g of powdered metallic zinc and diatomaceous earth in a 1:1 ratio by mass of zinc to diatomaceous earth. A field sample of 16.5 ppg ZnBr₂ brine contaminated with approximately 1000 mg/L (˜500 ppm) of iron was obtained, and 200 mL of this contaminated brine was circulated through the zinc/diatomaceous earth mixture in a continuous loop. After two hours, the concentration of iron in the brine was reduced to approximately 450 mg/L (˜225 ppm). After an additional 16 hours, the concentration of the iron was reduced to approximately 300 mg/L (˜150 ppm). The apparent decrease in efficiency that occurred after the first two hours can be explained by the brine solution channeling through only a particular portion of the filter media and hence not contacting the full available surface area. When the method is applied on a larger scale, such as commercial and/or on-site use, a more efficient plate and frame assembly, or other type filter arrangement can be used that can diminish the loss of efficiency seen in the lab experiment.

The term “high-density brine” refers to saturated or nearly saturated salt solutions that can be used as fluids for completion, workover, and other types of operations dealing with hydrocarbon exploration and production. As used herein the terms “high-density brine” and “brine” can refer to zinc-based brines.

The term “filter media” as used herein refers to material through which a brine solution is passed and that is capable of entrapping, and thereby removing, contaminants.

The term “contaminated” as used herein refers to the presence of chemicals or elements, such as iron, that render the brine solution unacceptable for reuse in a completion, workover, or other type of operation.

The term “soluble” as used herein refers to the ability of a chemical to be dissolved into a brine solution, such that it cannot be removed by ordinary filtering means. In contrast, the term “insoluble” as used herein refers to the inability of a chemical to be dissolved in a brine solution, such that it can be removed by means of filtration.

The term “reclaimed” refers to brine that has been processed for the removal of harmful contaminants and can be reused.

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method for the removal of soluble metal ion contamination from a fluid, comprising:
passing the fluid through a filter media comprising a reducing metal and a filter aid; and
collecting the filtrate;
wherein the reducing metal has a reduction potential of from −0.50 volt to −3.10 volt.

2. The method of claim 1, wherein the fluid is a high-density brine.

3. The method of claim 1, wherein the fluid is a zinc brine.

4. The method of claim 1, wherein the filter aid comprises diatomaceous earth.

5. The method of claim 4, wherein diatomaceous earth is additionally introduced into the contaminated fluid upstream of the filter.

6. The method of claim 1, wherein the reducing metal is zinc.

7. The method of claim 1, wherein the reducing metal is selected from the group consisting of: zinc, aluminum, magnesium, and combinations thereof.

8. The method of claim 1, wherein the filter media is used in a plate and frame type filter assembly.

9. The method of claim 1 performed on location at a well site.

10. The method of claim 1, wherein the filtrate contains a lower concentration of metal ion contaminants than the original contaminated fluid.

11. A filter medium for the removal of metal ion contamination from high-density brines comprising a reducing metal and a filter aid that reduces soluble metal ions to solid metal form and collects the solid metal in the filter.

12. The medium of claim 11, wherein the reducing metal has a reduction potential of from −0.50 volt to −3.10 volt.

13. The medium of claim 11, wherein the reducing metal is metallic zinc.

14. The medium of claim 11, wherein the filter medium comprises powdered metallic zinc and diatomaceous earth.

15. The medium of claim 11, wherein the soluble metal ions include iron(III) and iron(II) ions.

16. The medium of claim 11, wherein the filter medium is used in a plate and frame type filter assembly.

17. The medium of claim 16, wherein the filter assembly is used on location at a well site.

18. A method for the removal of iron contamination from high-density brines, comprising:
providing a high-density brine having iron contamination;
providing a filter media comprising a reducing metal and a filter aid;
passing the contaminated brine through the filter media;
reducing ferrous and/or ferric iron ions to insoluble iron through reaction with the reducing metal;
filtering out insoluble iron in the filter media; and
collecting the filtrate;
wherein the filtrate contains a lower concentration of iron contaminants than the contaminated brine.

19. The method of claim 18, wherein the high-density brine is zinc brine.

20. The method of claim 18, wherein the filter aid comprises diatomaceous earth.

21. The method of claim 18, wherein filter aid is additionally introduced into the contaminated brine upstream of the filter.

22. The method of claim 18, wherein the reducing metal is metallic zinc.

23. The method of claim 22, wherein the metallic zinc is used in the form of powdered zinc or zinc dust.

24. The method of claim 18, wherein the filter media is used in a plate and frame type filter assembly.

25. The method of claim 18, performed on location at a well site.

26. The method of claim 18, wherein the reducing metal has a reduction potential of from −0.50 volt to −3.10 volt.
